(19) United States
(12) Patent Application Publication
(10) Pub. No.: US 2026/0140241 A1
(43) Pub. Date: May 21, 2026

(54) CAMERA AND LIDAR CALIBRATION METHOD AND DATA GENERATION APPARATUS BASED ON PERSPECTIVE PROJECTION

(71) Applicant: MOBILTECH, Seoul (KR)

(72) Inventors: Jae Seung KIM, Seoul (KR); Sun Jae JEONG, Hwaseong-si (KR); Min Kyoung KIM, Seoul (KR); Soo Hwan KIM, Cheonan-si (KR)

(73) Assignee: MOBILTECH, Seoul (KR)

(21) Appl. No.: 19/345,430

(22) Filed: Sep. 30, 2025

(30) Foreign Application Priority Data
Nov. 15, 2024 (KR) 10-2024-0163383

(51) Int. Cl. G01S 7/497; G01S 17/87; G01S 17/894; G06T 7/80; H04N 17/00

(52) U.S. Cl. CPC G01S 7/497; G01S 17/87; G01S 17/894; G06T 7/80; H04N 17/002

(57) ABSTRACT

The disclosure relates to a method for calibrating parameters of a LiDAR sensor and a camera by considering characteristics of LiDAR data. A data generation apparatus extracts one frame of an image captured by a camera and one frame of point cloud data acquired by a LiDAR sensor, identifies feature points of a calibration board included in each of the extracted image and the extracted frame of the LiDAR sensor, and performs calibration of the camera and the LiDAR sensor based on the identified feature points. Performing the calibration includes generating a target plane by applying a RANSAC algorithm based on the feature points of the calibration board, and projecting the point cloud onto the target plane by performing a perspective projection.

### CROSS-REFERENCE TO RELATED APPLICATIONS AND CLAIM OF PRIORITY

The present application claims the benefit of priority to Korean Patent Application No. 10-2024-0163383, filed on Nov. 15, 2024, the entire disclosure of which is incorporated herein by reference.

### TECHNICAL FIELD

The present disclosure relates to the field of sensor fusion technology, and more particularly to a method for calibrating a camera and Light Detection and Ranging (LiDAR) sensor, and to a data generation apparatus configured to perform such calibration.

### BACKGROUND

In various fields such as autonomous driving, robotic navigation, and three-dimensional environment reconstruction, an increasing number of systems employ both a LiDAR sensor and a camera. The LiDAR sensor is configured to measure three-dimensional spatial information with high accuracy by using laser beams, and the camera is configured to provide rich color and texture information. To effectively fuse data obtained from the two sensors, a calibration process that aligns coordinate systems of the respective sensors with precision is essential.

Conventional calibration methods for a LiDAR sensor and a camera primarily employ feature points of a checkerboard to calculate parameters of the camera and the LiDAR sensor. However, the conventional methods fail to adequately consider characteristics of point cloud data generated by the LiDAR sensor, and such failure causes degradation of calibration accuracy.

In particular, the point cloud data obtained from the LiDAR sensor is based on distance information measured by laser beams. Therefore, a relationship between a position of the LiDAR sensor and each measured point must be considered. Conventional orthogonal projection methods ignore such characteristics of the point cloud data, and such ignorance causes reduced accuracy. Specifically, when a target plane is not perpendicular to a central axis of the LiDAR sensor or when the target plane is located close to the LiDAR sensor, projection of the point cloud data results in inaccurate calibration.

### ACKNOWLEDGMENT OF GOVERNMENT SUPPORT

This work was supported by the Technology Innovation Program (or Industrial Strategic Technology Development Program—Excellent Enterprise Research Institute Development Project (ATC+)), Project No. 20017992 (Development of real-time risk detection and mapping solutions based on 3D scanning technology to ensure safety during autonomous driving), funded by the Ministry of Trade, Industry and Energy (MOTIE, Korea).

### SUMMARY

The present disclosure has been made to address the problems described above. An object of the present disclosure is to provide a method that enables accurate and efficient calibration of a camera and a LiDAR sensor by taking into account characteristics of point cloud data acquired from the LiDAR sensor.

According to one embodiment, a calibration method includes: extracting, by a data generation apparatus, one frame of an image captured by the camera and one frame of point cloud data acquired by the LiDAR sensor; identifying, by the data generation apparatus, feature points of a calibration board included in the extracted image and the extracted frame of the LiDAR sensor; and performing, by the data generation apparatus, calibration of the camera and the LiDAR sensor based on the identified feature points so as to align coordinate systems of the camera and the LiDAR sensor.

Performing the calibration may include generating, by the data generation apparatus, a target plane by applying a Random Sample Consensus (RANSAC) algorithm based on the feature points of the calibration board, and projecting the point cloud onto the target plane by using a perspective projection method. Performing the calibration may further include calculating, for each LiDAR point on the target plane, a perspective projection distance by using a vector from a center coordinate of the LiDAR to the LiDAR point and a normal vector of the target plane, and projecting the LiDAR point onto the target plane based on the calculated distance, thereby reflecting a ray-casting process of the LiDAR sensor.

The calibration may be performed selectively by using at least one of perspective projection and orthogonal projection. In one embodiment, when an angle between a ray direction of the LiDAR sensor and a normal vector of the target plane exceeds a predetermined angle, the point cloud is projected onto the target plane by the perspective projection method, thereby improving calibration accuracy. In another embodiment, when a distance between the LiDAR sensor and the target plane is less than a predetermined distance, the point cloud is projected onto the target plane by the perspective projection method, thereby enhancing calibration precision.

The calibration may further include calculating extrinsic parameters including a rotation value and a translation value based on the feature points included in the image and the point cloud data, and performing calibration by using the calculated extrinsic parameters. The rotation value and the translation value may be calculated separately, thereby enabling more accurate parameter estimation.

According to another embodiment, a data generation apparatus configured to perform calibration of a camera and a LiDAR sensor based on perspective projection includes a memory and at least one processor communicatively coupled to the memory. The at least one processor is configured to extract one frame of an image captured by the camera and one frame of point cloud data acquired by the LiDAR sensor, identify feature points of a calibration board included in the extracted image and the extracted frame of the LiDAR sensor, perform calibration of the camera and the LiDAR sensor based on the identified feature points, generate a target plane by applying a RANSAC algorithm based on the feature points of the calibration board, and project the point cloud onto the target plane by using the perspective projection method so as to align the camera and the LiDAR sensor.

According to the present disclosure, parameters of the camera and the LiDAR sensor can be calibrated with improved accuracy and efficiency. In particular, by employing the perspective projection method that reflects characteristics of the LiDAR data, the calibration faithfully reflects the ray-casting process of the LiDAR sensor. The calibration method according to the present disclosure enhances performance of autonomous driving systems, robotic navigation systems, and three-dimensional environment reconstruction systems that employ both a camera and a LiDAR sensor.

### BRIEF DESCRIPTION OF THE DRAWINGS

The drawings accompanying the present specification illustrate embodiments of the present disclosure and, together with the description, serve to explain principles of the disclosure. In the drawings:

FIG. 1 illustrates a configuration of a data generation system according to an embodiment of the present disclosure.

FIG. 2 illustrates a logical configuration of a data generation apparatus according to an embodiment of the present disclosure.

FIG. 3 illustrates a hardware configuration of a data generation apparatus according to an embodiment of the present disclosure.

FIG. 4 illustrates a flowchart for explaining a calibration method of a camera and a Light Detection and Ranging (LiDAR) sensor according to an embodiment of the present disclosure.

FIG. 5 illustrates a diagram for explaining a perspective projection according to an embodiment of the present disclosure.

FIG. 6 illustrates a diagram for comparing effects of perspective projection and orthogonal projection according to an embodiment of the present disclosure.

FIG. 7 illustrates a diagram for explaining an operation of determining a target plane according to an embodiment of the present disclosure.

FIG. 8 illustrates a diagram for explaining an operation of determining an intersection of a lidar ray and a target plane according to an embodiment of the present disclosure.

FIG. 9 illustrates a diagram for explaining an operation of projecting onto a target plane by using a perspective projection distance according to an embodiment of the present disclosure.

### DETAILED DESCRIPTION

Technical terms used in the present specification are employed merely for describing specific embodiments and are not intended to limit the present disclosure. Unless expressly defined otherwise herein, technical terms used in the present specification shall be interpreted in accordance with meanings generally understood by a person skilled in the art to which the present disclosure pertains, and shall not be interpreted in an unduly broad or unduly narrow sense. Furthermore, if a technical term used in the present specification fails to accurately express the spirit of the present disclosure, the technical term shall be replaced with a term that can be properly understood by a person skilled in the art.

General terms used in the present specification shall be interpreted according to dictionary definitions or according to the context in which the terms are used, and shall not be interpreted in an unduly narrow sense. Singular expressions used in the present specification shall be construed to include plural expressions unless the context clearly dictates otherwise. Terms such as “comprises” and “has” used in the present specification shall not be construed as necessarily including all components or all steps described herein, but shall be construed as possibly excluding some components or steps or including additional components or steps.

Ordinal terms such as “first” and “second” may be used to describe various elements, but the elements shall not be limited by such terms. The terms are employed only to distinguish one element from another. For example, a first element may be referred to as a second element, and similarly, the second element may also be referred to as the first element, without departing from the scope of the present disclosure.

When an element is described as being “connected” or “coupled” to another element, the element may be directly connected or coupled to the other element, or an intervening element may be present. In contrast, when an element is described as being “directly connected” or “directly coupled” to another element, no intervening element shall be understood to be present.

Hereinafter, preferred embodiments of the present disclosure will be described in detail with reference to the accompanying drawings. In the drawings, identical or similar elements are assigned the same reference numerals regardless of figure numbers, and redundant descriptions thereof will be omitted. In describing the present disclosure, detailed descriptions of well-known techniques will be omitted if it is determined that such detailed descriptions would obscure the gist of the present disclosure. The accompanying drawings are provided only to facilitate understanding of the spirit of the present disclosure, and the scope of the present disclosure shall not be construed as being limited by the drawings. The scope of the present disclosure shall be construed to extend to all modifications, equivalents, and substitutions in addition to those illustrated in the drawings.

A Mobile Mapping System (MMS) may be mounted on a vehicle in order to acquire positional information and visual information of surrounding geographic features while the vehicle is in motion. The MMS may be configured based on information collected by various sensors, including a Global Positioning System (GPS) for acquiring positional and attitude information of the vehicle body, an Inertial Navigation System (INS), an Inertial Measurement Unit (IMU), a camera for collecting shape and texture information of geographic features, a Light Detection and Ranging (LiDAR) sensor, and other sensors.

However, as described above, the various sensors used to acquire, capture, or measure data cannot be physically installed at an identical location, and since each sensor operates based on its own time information, synchronization among the sensors cannot be achieved.

Meanwhile, a Simultaneous Localization and Mapping (SLAM) system may estimate a pose of a vehicle while simultaneously constructing a three-dimensional map, based on information collected by the GPS, the INS, the IMU, the camera, the LiDAR sensor, and other sensors. However, conventional SLAM systems impose excessive computational load due to complex operations, and as a result, a significant amount of time is required for localization and map construction.

In order to overcome such limitations, the present disclosure provides various means for performing calibration among multiple sensors and for generating an accurate feature map.

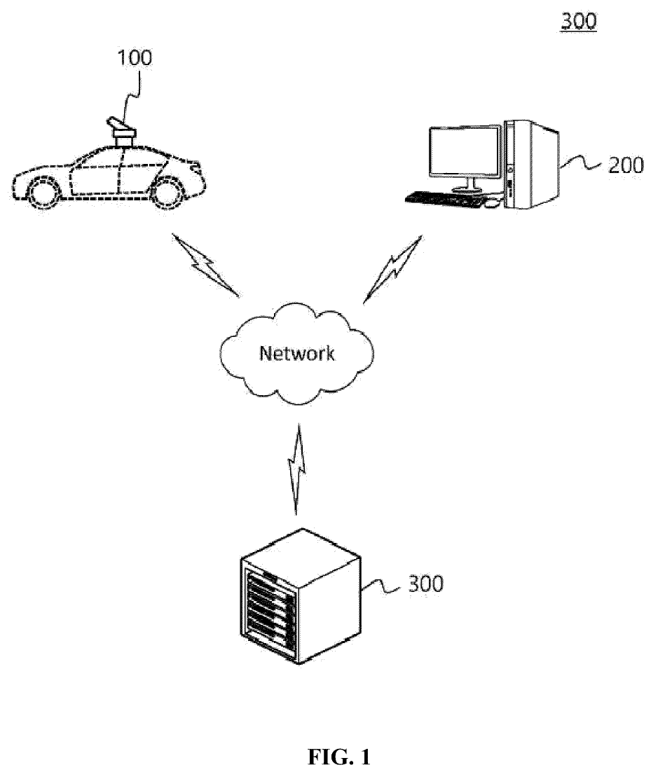

FIG. 1 illustrates a configuration of a data generation system according to an embodiment of the present disclosure. Referring to FIG. 1, the data generation system according to the embodiment of the present disclosure may include a data collection apparatus 100, a data generation apparatus 200, and a data processing apparatus 300.

Components of the data generation system according to the embodiment of the present disclosure merely represent functionally distinguishable elements. Therefore, in an actual physical environment, two or more components may be integrated and implemented together, or one component may be divided and implemented separately.

Describing each component, the data collection apparatus 100 may be mounted on a vehicle and may cause collection of data required for map generation and learning data generation. The data collection apparatus 100 may include at least one of a LiDAR sensor, a camera, a radar (radar), an Inertial Measurement Unit (IMU), and a Global Positioning System (GPS). However, the data collection apparatus 100 is not limited thereto, and various sensors capable of sensing information for generating a high-definition road map may be applied.

Specifically, the data collection apparatus 100 may cause acquisition of point cloud data from the LiDAR sensor and may cause acquisition of an image captured by the camera. In addition, the data collection apparatus 100 may cause acquisition of information related to position and pose from the IMU and the GPS.

The LiDAR sensor may cause emission of laser pulses around the vehicle, may cause detection of light reflected from objects located around the vehicle, and may generate point cloud data corresponding to a three-dimensional image of the surroundings of the vehicle. The camera may cause acquisition of an image of a space corresponding to the LiDAR sensor. The camera may include one of a color camera, a Near InfraRed (NIR) camera, a Short Wavelength InfraRed (SWIR) camera, and a Long Wavelength InfraRed (LWIR) camera.

The IMU may include an acceleration sensor and a gyroscope, and in some cases, may further include a magnetometer, and may cause detection of changes in acceleration resulting from changes in motion of the data collection apparatus 100. The GPS may receive signals transmitted from satellites and may cause measurement of a position of the data collection apparatus 100 by using triangulation.

The data collection apparatus 100 may be installed on a vehicle or an aerial apparatus. For example, the data collection apparatus 100 may be installed on an upper portion of a vehicle to collect surrounding point cloud data or images, or may be installed on a lower portion of an aerial apparatus to collect point cloud data or images of objects on the ground from the air. The data collection apparatus 100 may transmit collected point cloud data or images to the data generation apparatus 200.

In a subsequent configuration, the data generation apparatus 200 may receive point cloud data acquired by the LiDAR sensor and images captured by the camera from the data collection apparatus 100. The data generation apparatus 200 may cause generation of a high-definition road map by using the received point cloud data and images, and may cause generation of learning data utilizing the high-definition road map.

Characteristically, according to one embodiment of the present disclosure, the data generation apparatus 200 may extract one frame of an image captured by the camera and one frame of point cloud data acquired by the LiDAR sensor, and may identify feature points of a calibration board included in each of the extracted frame of the image and the extracted frame of the LiDAR sensor. The data generation apparatus 200 may cause calibration of the camera and the LiDAR sensor based on the identified feature points.

According to another embodiment of the present disclosure, the data generation apparatus 200 may place point cloud data acquired from a LiDAR sensor mounted on a vehicle onto a predefined world coordinate system, and may extract a region to be used for calibration from the placed point cloud data. The data generation apparatus 200 may identify at least one object included in the extracted region, and may cause calibration of the point cloud data by fitting the point cloud corresponding to the identified at least one object to a pre-stored model (model).

According to another embodiment of the present disclosure, the data generation apparatus 200 may obtain first point cloud data acquired from a first LiDAR sensor, a plurality of second point cloud data acquired from a plurality of second LiDAR sensors mounted on a vehicle traveling along a path on a reference map, and specification values of the first LiDAR and the plurality of second LiDAR sensors. The data generation apparatus 200 may cause preprocessing of the first point cloud data and the plurality of second point cloud data, and may cause calibration of the preprocessed first point cloud data and the plurality of second point cloud data.

According to still another embodiment of the present disclosure, the data generation apparatus 200 may cause generation of a first feature map based on point cloud data acquired from the LiDAR sensor and images captured by the camera, and may cause generation of a third feature map by mapping the first feature map to a second feature map generated from pre-stored point cloud data.

Although various embodiments of the present disclosure are described as being distinguished from one another and performing individual functions, the present disclosure is not limited thereto, and functions of the respective embodiments may be combined and applied together.

The data generation apparatus 200 having such features may be any apparatus that transmits and receives data to and from the data collection apparatus 100 and the data processing apparatus 300, and performs computation based on the transmitted and received data. For example, the data generation apparatus 200 may be a fixed computing device such as a desktop, a workstation, or a server, but is not limited thereto.

In a subsequent configuration, the data processing apparatus 300 may process a map generated by the data generation apparatus 200. For example, the data processing apparatus 300 may cause correction of facility information in the map generated by the data generation apparatus 200, or may cause removal of noise from the generated map. The data processing apparatus 300 may also cause detection of a specific object from the generated map, or may cause lightweight processing of the data.

The data processing apparatus 300 having such features may be any apparatus that transmits and receives data to and from the data collection apparatus 100 and the data generation apparatus 200, and performs computation based on the transmitted and received data. For example, the data processing apparatus 300 may be a fixed computing device such as a desktop, a workstation, or a server, but is not limited thereto.

The data collection apparatus 100, the data generation apparatus 200, and the data processing apparatus 300, as described above, may transmit and receive data through a network composed of at least one of a secure dedicated line directly connecting the devices, a public wired communication network, or a mobile communication network. For example, the public wired communication network may include Ethernet, a Digital Subscriber Line (xDSL), a Hybrid Fiber Coax (HFC) network, and a Fiber To The Home (FTTH) network, but is not limited thereto. The mobile communication network may include Code Division Multiple Access (CDMA), Wideband CDMA (WCDMA), High Speed Packet Access (HSPA), Long Term Evolution (LTE), and 5th generation mobile telecommunication (5G), but is not limited thereto.

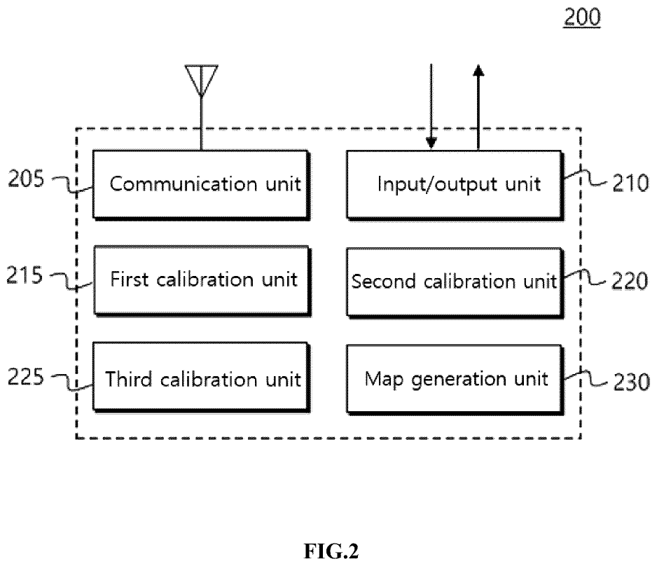

FIG. 2 illustrates a logical configuration of a data generation apparatus according to an embodiment of the present disclosure. Referring to FIG. 2, the data generation apparatus 200 according to the embodiment of the present disclosure may include a communication unit 205, an input/output unit 210, a first calibration unit 215, a second calibration unit 220, a third calibration unit 225, and a map generation unit 230.

Components of the data generation apparatus 200 merely represent functionally distinguishable elements. Therefore, in an actual physical environment, two or more components may be integrated and implemented together, or one component may be divided and implemented separately.

Describing each component, the communication unit 205 may transmit and receive data to and from the data collection apparatus 100 and the data processing apparatus 300. Specifically, the communication unit 205 may receive point cloud data acquired by the LiDAR sensor and images captured by the camera from the data collection apparatus 100.

The input/output unit 210 may receive signals from a user through a user interface (UI), or may output computation results to the outside. Specifically, the input/output unit 210 may receive setting information for calibration among sensors. In addition, the input/output unit 210 may output calibration results and a generated map.

The first calibration unit 215 may cause calibration between the camera and the LiDAR sensor. Specifically, the first calibration unit 215 may extract one frame of an image captured by the camera and one frame of point cloud data acquired by the LiDAR sensor. The extracted image and the extracted frame of the LiDAR sensor may include a calibration board.

The first calibration unit 215 may identify feature points of the calibration board included in each of the extracted frame of the image and the extracted frame of the LiDAR sensor. The calibration board may a rectangular checker board, the checker board including a boundary identification region, the boundary identification region being formed of a material having an intensity higher than a preset value and a top point identification region formed of a material having an intensity lower than a preset value and located at an upper end of the boundary region. For example, the calibration board may include a boundary identification region formed by attaching a high-intensity tape along the boundary of the checker board, and a portion of the high-intensity tape located at the uppermost portion of the calibration board may be removed to form the top point identification region.

The first calibration unit 215 may identify corners of the calibration board in the image based on a size and a number of the calibration boards (calibration boards). For example, the first calibration unit 215 may extract the calibration board from the image by using a source checker board image corresponding to the calibration board, the number of internal corners per row and column of the checker board, and an output array of detected corners, and may identify corners of the extracted calibration board.

The first calibration unit 215 may assign an index to points corresponding to the corners by identifying the points based on a preset pattern with reference to feature points located at an uppermost portion or a lowermost portion of the calibration board. For example, the first calibration unit 215 may assign indices in a manner of increasing numbers from an uppermost feature point of the calibration board toward the lower right, or may assign indices in a manner of increasing numbers from a lowermost feature point of the calibration board toward the upper left.

The first calibration unit 215 may detect the calibration board in the point cloud data based on the boundary identification region having relatively high intensity, and may identify feature points within the detected calibration board. Specifically, the first calibration unit 215 may generate a target plane based on point clouds included in the boundary identification region, and may generate a plurality of straight lines by connecting points located at outermost positions in each channel of the generated virtual plane. The first calibration unit 215 may detect vertices of the calibration board based on intersections of the plurality of generated straight lines, and may identify feature points of the calibration board based on the detected vertices.

In other words, the first calibration unit 215 may identify four vertices included in the calibration board, and may identify feature points of the calibration board based on a pre-stored size and number of the calibration board. Feature points of the calibration board identified from the point cloud data may correspond to feature points identified from the image. The first calibration unit 215 may match indices of the feature points identified from the image to the feature points identified from the LiDAR sensor, based on the top point identification region of the calibration board.

The first calibration unit 215 may cause calibration of the camera and the LiDAR sensor based on the feature points identified from the image and the feature points identified from the point cloud data.

Specifically, the first calibration unit 215 may calculate extrinsic parameters including a rotation value and a translation value, based on feature points of the calibration board included in the image and the point cloud data, and may cause calibration based on the calculated extrinsic parameters.

The first calibration unit 215 may calculate the rotation value and the translation value separately. Preferably, the first calibration unit 215 may calculate the rotation value first, and then may calculate the translation value.

First, when the rotation value is defined as a rotation value from a first viewpoint to a second viewpoint, the rotation value may be calculated by Equation 1 below.

$$\vert ( {f}_{1}^{*} {Rf}_{1}^{′} ) ( {f}_{2}^{*} {Rf}^{′} 2 ) ( {f}_{3}^{*} {Rf}_{3}^{′} ) \vert = 0 \qquad [ Equation 1 ]$$

Here, R denotes the rotation value, and f and f′ denote rays from the first viewpoint and the second viewpoint, respectively, to feature points of the calibration board included in the point cloud data. The translation value may be calculated through a loss function based on Re-Projection Error (RPE). The RPE may indicate a degree of distortion of a point projected onto an image relative to an observed point in the image.

In a subsequent configuration, the second calibration unit 220 may cause calibration between the LiDAR sensor and an Inertial Measurement Unit (IMU) by using features corresponding to a shape of a specific object included in the point cloud data acquired from the LiDAR. Specifically, the second calibration unit 220 may place the point cloud data acquired from the LiDAR mounted on a vehicle onto a predefined world coordinate system. At this time, the second calibration unit 220 may define the world coordinate system based on position information measured by at least one of a Global Positioning System (GPS) and an IMU acquired simultaneously with the point cloud data.

The second calibration unit 220 may extract a region to be used for calibration from the placed point cloud data. Specifically, the second calibration unit 220 may extract a trajectory of movement of the vehicle on which the LiDAR sensor is mounted, the trajectory having a heading standard deviation of GPS data lower than a preset value, and may further extract a section of the trajectory including segments in which traveling directions of the vehicle are opposite to each other.

Generally, GPS data is post-processed by using various data including GPS, the IMU, a Distance Measurement Instrument (DMI), and base station information. Even after post-processing with other data, GPS data may still contain errors caused by influences of objects such as tall buildings composed of highly reflective materials. Calibration must be performed at a position where an error of the GPS data is minimized in order to cause improvement in accuracy. Accordingly, the second calibration unit 220 may extract an optimal trajectory from the entire section for calibration.

Furthermore, when calibration is performed by using only a trajectory corresponding to a section in which the vehicle travels in one direction, even among trajectories having a heading standard deviation lower than a preset value, tilting is not considered and therefore a generated map may be distorted. Accordingly, the second calibration unit 220 may extract a section of the trajectory in which trajectories having opposite traveling directions of the vehicle are simultaneously included.

For example, the second calibration unit 220 may generate heading standard deviation values by quantiles, may extract a trajectory corresponding to the lower 10% of the heading standard deviation values, and may operate a sliding window of a predetermined size to determine whether two or more separated trajectories are included within the window. When two or more trajectories are present within the window, the second calibration unit 220 may calculate average heading values of the respective trajectories to determine whether trajectories having opposite directions are present, and if present, may determine the corresponding section as an appropriate trajectory for calibration.

Next, the second calibration unit 220 may identify at least one object included in the extracted region.

As an object to be used for calibration, a spherical object is most suitable because the spherical shape allows consideration of all the x-axis, y-axis, and z-axis, and causes identification of distortion in any direction. However, in practice, spherical objects are relatively rare.

Alternatively, when calibration is performed based on a wall, calibration may be possible in a direction perpendicular to the wall. However, calibration in a horizontal direction parallel to the wall is difficult, and therefore two or more parallel walls must be used to perform calibration in the horizontal direction.

Accordingly, the second calibration unit 220 may use cylindrical objects, which exist relatively abundantly in real environments and allow horizontal fitting, for calibration. That is, the second calibration unit 220 may identify cylindrical objects for horizontal fitting from the placed point cloud data. For example, cylindrical objects may include street lamps, utility poles, and traffic lights.

The second calibration unit 220 may also identify a ground surface for vertical fitting from the placed point cloud data. In this case, the second calibration unit 220 may extract a region of a preset size based on a midpoint of the extracted trajectory, and may recognize the region as the ground surface. That is, the second calibration unit 220, under the assumption that the vehicle equipped with the data collection apparatus 100 travels on a road, may extract a region of a preset size along the x-axis and the y-axis from the midpoint of the extracted trajectory, and may recognize the extracted region as the ground surface.

The second calibration unit 220 may cause calibration of the point cloud data by fitting point clouds included in the identified at least one object to a pre-stored model. Specifically, the second calibration unit 220 may calculate a loss for a cylindrical object by dividing a number of inlier points fitted to a pre-stored cylinder model corresponding to the cylindrical object by a total number of point clouds included in the cylindrical object. The second calibration unit 220 may also calculate a loss for the ground surface by dividing a number of inlier points fitted to a pre-stored ground model by a total number of point clouds included in the ground surface.

The second calibration unit 220 may cause calibration of the point cloud data through a loss function configured based on the loss for the cylindrical object and the loss for the ground surface. The second calibration unit 220 may configure the loss function as shown in the following code.

$$double loss = ( - 1 ) * pole\_loss + ( - 1 ) * ground\_loss$$

where pole_loss denotes a loss for an object, and ground_loss denotes a loss for the ground surface.

Assuming that a number of point clouds of an identified object is n, and that i denotes a number of inlier points of a cylinder model fitted by applying a Random Sample Consensus (RANSAC) algorithm, the loss for the object may be calculated by the following code:

$$pole\_loss = i / n$$

Similarly, assuming that a number of point clouds of an identified ground surface is n, and that i denotes a number of inlier points of a ground model fitted by applying a RANSAC algorithm, the loss for the ground surface may be calculated by the following code:

$$ground\_loss = i / n$$

In contrast to vertical fitting that considers only the z-axis, horizontal fitting that considers both the x-axis and the y-axis may cause a problem in which losses are calculated in an imbalanced manner. Such imbalance of losses may cause difficulty in convergence to a correct solution during the calibration process, because the calibration process tends to search near a local minimum after the ground surface has already been fitted and the loss has already decreased, rather than moving toward another area.

Accordingly, the second calibration unit 220 may add a ratio loss, corresponding to a ratio between the loss for the cylindrical object and the loss for the ground surface, to the loss function. The ratio loss may be calculated by the following code:

$$double ratio\_loss ;$$

$$if ( pole\_loss > ground\_loss )$$

$$ratio\_loss = ground\_loss / pole\_loss ;$$

$$else // pole\_loss < ground\_loss$$

$$ratio\_loss = pole\_loss / ground\_loss ;$$

Finally, the second calibration unit 220 may configure the loss function as shown in the following code:

$$double lambda = 0.5 ;$$

$$double loss = ( - 1 ) * pole\_loss + ( - 1 ) * ground\_loss + ( - 1 ) * ratio\_loss * lambda ;$$

where λ=0.5 may solve a problem in which the loss no longer decreases when the loss for the object and the loss for the ground surface are equal.

The second calibration unit 220 may cause calibration of the point cloud data by using the loss function through Particle Swarm Optimization (PSO).

For example, the Particle Swarm Optimization (PSO) may be configured as shown in the following code:

Algorithm 1: Particle Swarm Optimization

| | | | Input : | Objective function f : X → R, | |
|---|---|---|---|---|---|
| | | | | Termination condition [symbol] : X → B, | |
| | | | | Population size: X, | |
| | | | | Lower and upper bounds of the solution: b [symbol] and b [symbol] , | |
| | | | | Maximum influence values φ₁ and φ₂ | |
| | Output: | | | Best solution g | |
| 1 | // Step 1: Initialization. | | | | |
| 2 | Randomly initialize the population P = [x [symbol] x [symbol] x [symbol] ]. | | | | |
| 3 | Randomly initialize the particle's velocity within [b, [symbol] b [symbol] ]. | | | | |
| 4 | repeat | | | | |
| 5 | \| | for i ∈ [ [symbol] ] do | | | |
| 6 | \| | \| | // Step 2: Velocity Calculation. | | |
| 7 | \| | \| | // d is a dimensionality of the input space X, | | |
| 8 | \| | \| | Generate a random vector r₁ ~ U[0,φ₁]^{d} | | |
| 9 | \| | \| | Generate a random vector r₂ ~ U[0,φ₂]^{d} | | |
| 10 | \| | \| | v₁^{(k+1)} ← v₁^{(k)} + r₃(p₃ − x₁^{(k)}) + r₂(g − x₁^{(k)}) | | |
| 11 | \| | \| | // Step 3: Position Update | | |
| 12 | \| | \| | x₁^{(k+1)} ← x₁^{(k)} + v₁^{(k+1)} | | |
| 13 | \| | \| | // Step 4: Evaluation | | |
| 14 | \| | \| | if f(x₁^{(k+1)} < f(pᵢ) then | | |
| 15 | \| | \| | \| | p [symbol] ← x; | |
| 16 | \| | \| | \| | if f(pᵢ) < f(g) then | |
| 17 | \| | \| | \| | \| | κ ← p [symbol] |

| | | | | |
|---|---|---|---|---|
| 28 | \| | \| | \| | end |

| | | | |
|---|---|---|---|
| 19 | \| | \| | end |

| | | |
|---|---|---|
| 20 | \| | end |

| | |
|---|---|
| 21 | until [symbol] (X) = = TRUE [symbol] |
| 22 | return g |

[symbol]

indicates data missing or illegible when filed

In addition, the second calibration unit 220 may configure the loss function in a manner that causes optimization by using variance of point clouds of the identified object. Specifically, the second calibration unit 220 may construct at least one identified object into an octree, and may cause calibration of the point cloud data by using a variance summation of leaf nodes of the constructed octree as the loss.

At this time, the second calibration unit 220 may add a length of the z-axis of the point cloud data to the variance summation loss in order to configure the loss function, and may cause calibration of the point cloud data based on the loss function. Through this, the second calibration unit 220 may configure a loss function for ground surface fitting that is continuous and free from randomness.

In a subsequent configuration, the third calibration unit 225 may cause calibration among a plurality of LiDAR sensors. First, the third calibration unit 225 may obtain first point cloud data acquired from a first LiDAR sensor, a plurality of second point cloud data acquired from a plurality of second LiDAR sensors mounted on a vehicle traveling along a path on a reference map, and specification values of the first LiDAR and the plurality of second LiDAR sensors.

For example, the first LiDAR may be a LiDAR for generating the reference map, and the plurality of second LiDAR sensors may be LiDAR sensors mounted on a vehicle traveling along the path of the map to update the generated map. The plurality of second LiDAR sensors may include a LiDAR configured to acquire point cloud data for a front side of the vehicle, a LiDAR configured to acquire point cloud data for a rear side of the vehicle, and a LiDAR sensor mounted on a roof of the vehicle to acquire 360-degree point cloud data.

Next, the third calibration unit 225 may cause preprocessing of the first point cloud data and the plurality of second point cloud data. Specifically, the third calibration unit 225 may voxelize the first point cloud data and the plurality of second point cloud data. Through this, the third calibration unit 225 may reduce a difference in the number of points between the first LiDAR sensor and any of the plurality of second LiDAR sensor s, and may remove noise.

In addition, the third calibration unit 225 may calculate an average and a standard deviation based on distances among points in the first point cloud data and the plurality of second point cloud data, and may define points having deviations greater than a preset value as outliers to perform preprocessing.

Since calibration is performed between the LiDAR for generating the reference map and the LiDAR sensors mounted on the vehicle, point clouds corresponding to objects such as vehicles or pedestrians, which do not exist on the reference map, may cause errors in calibration. Accordingly, the third calibration unit 225 may detect ground surfaces from the plurality of second point cloud data, and may remove objects having heights greater than a preset value with reference to the detected ground surfaces. That is, the third calibration unit 225 may perform preprocessing of deleting objects such as vehicles and pedestrians by identifying such objects based on heights from the ground surface.

In addition, a fitness score used in Normal Distribution Transform (NDT) matching, which will be described later, may indicate an average distance of points, among the plurality of second point cloud data, for which each point corresponds to a closest point of the first point cloud data and the distance is smaller than a predetermined value. Accordingly, in order to reduce errors in z-axis values of the plurality of second LiDAR sensors, a ratio of the ground surface must be as large as that of walls and pillars.

Accordingly, the third calibration unit 225 may detect ground surfaces from the plurality of second point cloud data, may approximate the point clouds detected as the ground surface into a plane, and may interpolate additional points among the point clouds detected as the ground surface.

Next, the third calibration unit 225 may cause calibration of the preprocessed first point cloud data and the plurality of second point cloud data. Specifically, the third calibration unit 225 may cause calibration of the plurality of second LiDAR sensors simultaneously by using multi-threading.

For calibration, the third calibration unit 225 may perform Normal Distribution Transform (NDT) matching on the first point cloud data and each of the plurality of second point cloud data. At this time, the third calibration unit 225 may designate specification values of the first LiDAR sensor and each of the plurality of second LiDAR sensors as initial poses for calibration.

The NDT matching is an algorithm that calculates a transformation matrix through matching between point cloud data, and minimizes errors of points by calculating the errors as normal distributions when the first point cloud data and each of the plurality of second point cloud data overlap. That is, the NDT algorithm is an algorithm that causes alignment of each of the plurality of second point cloud data with the first point cloud data, by dividing the first point cloud data into grids of a predetermined size, approximating point clouds included in each grid as a normal distribution, and optimizing rotation values and translation values in a manner that increases probabilities of points of each of the plurality of second point cloud data being included in the grids.

The third calibration unit 225 may use a fitness score, which is a value obtained by summing errors of averages and covariances among voxels during the NDT matching process, to determine alignment between the first point cloud data and the plurality of second point cloud data. The fitness score may indicate an average distance of points, among the plurality of second point cloud data transformed by a pose resulting from the NDT matching, for which each point corresponds to a closest point of the first point cloud data and the distance is smaller than a predetermined value. At this time, the third calibration unit 225 may extract a pose corresponding to a point at which the fitness score decreases below a preset value. The third calibration unit 225 may verify calibration by comparing the fitness score at completion of the NDT matching with the preset value.

In addition, the third calibration unit 225 may assign a Region Of Interest (ROI) to each of the plurality of second point cloud data and may perform Normal Distribution Transform (NDT) matching with the first point cloud data. At this time, the third calibration unit 225 may assign the Region Of Interest (ROI) to each of the plurality of second point cloud data with reference to a coordinate system of the first point cloud data, and may assign the Region Of Interest (ROI) after aligning coordinate systems of the first point cloud data and the plurality of second point cloud data by using specification values of the plurality of second LiDAR sensors. The third calibration unit 225 may determine alignment between the first point cloud data and the plurality of second point cloud data by using a fitness score of the assigned Region Of Interest (ROI). At this time, the third calibration unit 225 may extract a pose corresponding to a point at which the fitness score decreases below a preset value. For example, the third calibration unit 225 may receive a region expected to be motionless from an operator as the Region Of Interest (ROI).

The third calibration unit 225 may perform NDT matching by changing yaw values of each of the plurality of second point cloud data by a preset angle, and may extract a pose corresponding to a point at which the fitness score decreases below a preset value, and may re-input the extracted pose as an initial pose of the NDT matching. For example, the third calibration unit 225 may change a yaw value of one of the plurality of second LiDAR sensors within a range of ±3° at intervals of 0.1°, and may perform NDT matching to obtain a minimum fitness score and a pose corresponding to the minimum fitness score. The third calibration unit 225 may re-input the minimum fitness score and the pose corresponding to the minimum fitness score as the initial pose of the NDT matching, and may adopt the pose at a time when the pose converges through repeated NDT matching as a calibration result.

In a subsequent configuration, the map generation unit 230 may cause generation of a feature map by mapping feature points of images captured by the camera to point cloud data acquired by the LiDAR sensor. For this purpose, the map generation unit 230 may cause generation of a first feature map based on the point cloud data acquired by the LiDAR sensor and images captured by the camera. Specifically, the map generation unit 230 may acquire the point cloud data and the images through a LiDAR sensor mounted on a vehicle and a camera installed at a position identical to the LiDAR sensor.

The map generation unit 230 may extract feature points from the acquired images, and may cause generation of the first feature map composed of the extracted feature points. The map generation unit 230 may extract feature points based on brightness continuity of pixels existing within a preset range from each pixel included in the image. That is, the map generation unit 230 may determine a specific pixel as a corner point when n or more consecutive pixels brighter than a predetermined value than the specific pixel are present, or when n or more consecutive pixels darker than a predetermined value than the specific pixel are present.

For this purpose, the map generation unit 230 may use a decision tree to determine whether a pixel is a corner point. That is, the map generation unit 230 may classify brightness values of pixels into three values including much darker than a specific pixel, similar to the specific pixel, and much brighter than the specific pixel, and may represent brightness distributions of pixels on a circumference as a ternary vector of 16 dimensions. The map generation unit 230 may classify whether the pixel is a corner point by inputting the represented ternary vector into the decision tree.

In addition, the map generation unit 230 may apply stepwise downscaling and blurring to the image at a preset scale, may extract contours and corners included in the image by using a Difference of Gaussian (DoG) function, may extract pixels corresponding to maxima and minima for each pixel of the image composed of the extracted contours and corners, and may extract pixels having the maxima and minima as feature points.

In addition, the map generation unit 230 may detect corners by setting a window centered on each pixel included in the image, and by moving the set window by a preset direction and distance. For example, the map generation unit 230 may calculate image variation amounts when moving the window by one pixel in four directions of vertical, horizontal, left diagonal, and right diagonal with respect to each pixel position, may set a minimum value of the image variation amounts as an image variation value of the corresponding pixel, and may classify a point at which the minimum value becomes a local maximum as a corner point.

As a result, the map generation unit 230 may cause generation of a feature map based on feature points located at detected corners among the feature points extracted based on brightness continuity. That is, the map generation unit 230 may cause generation of a first feature map composed only of the feature points extracted from the image.

Next, the map generation unit 230 may cause generation of a third feature map by mapping a first feature map to a second feature map generated from pre-stored point cloud data. Specifically, the map generation unit 230 may map the first feature map to the second feature map based on position information and pose information of point cloud data acquired simultaneously with the image for generating the first feature map.

The second feature map may be a point cloud map generated by using point cloud data acquired by the same equipment that acquires the image and the point cloud data for generating the first feature map. Accordingly, the map generation unit 230 may omit a pose optimization process when mapping the first feature map to the second feature map. Through this, the map generation unit 230 may not only cause generation of a lightweight feature map composed only of feature points, but also may cause generation of the third feature map at high speed.

In addition, after generating the third feature map, the map generation unit 230 may receive at least one image in real time for position estimation. The map generation unit 230 may extract feature points by analyzing the received at least one image in real time. The map generation unit 230 may extract feature points from the image in the same manner as described above for generating the first feature map.

The map generation unit 230 may match the extracted feature points with the third feature map to estimate a position on the real-time received image. At this time, the map generation unit 230 may estimate a pose of a camera of the data collection apparatus 100 based on information on the feature points of the real-time received at least one image and the feature points of the third feature map. For example, the map generation unit 230 may calculate a current position and pose on the image by using a pnp solver function. That is, the map generation unit 230 may estimate a position and a pose of the camera that captures the real-time received image, based on the feature points of the real-time received image and the feature points of the third feature map.

In addition, when position estimation for a first image among the at least one image fails, the map generation unit 230 may estimate a position of the first image based on a pose of a second image that is an image for which position estimation has been successful. That is, the map generation unit 230 may predict a position of the image that fails in position estimation, based on a position and a pose of a previously captured image.

Meanwhile, the real-time received at least one image may be an image captured by a terminal equipped with a camera and an Inertial Measurement Unit (IMU). At this time, the map generation unit 230 may increase accuracy of position and pose estimation for the image that fails in position estimation, by estimating a position of the first image based on a pose of the second image and by reflecting a pose measured by the Inertial Measurement Unit (IMU).

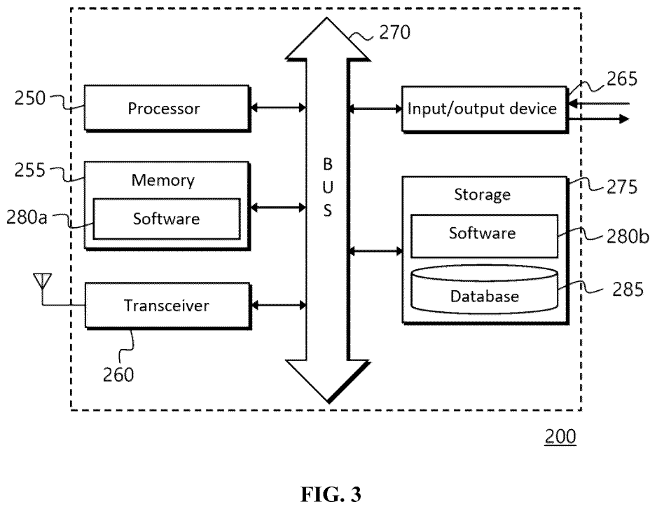

FIG. 3 illustrates a hardware configuration of a data generation apparatus according to an embodiment of the present disclosure. Referring to FIG. 3, the data generation apparatus 200 according to the embodiment of the present disclosure may include a processor 250, a memory 255, a transceiver 260, an input/output device 265, a data bus 270, and a storage 275.

The processor 250 may cause implementation of operations and functions of the data generation apparatus 200 based on instructions of software 280a resident in the memory 255. The memory 255 may store software 280a implementing a method according to the present disclosure. The transceiver 260 may transmit and receive data to and from the data collection apparatus 100 and the data processing apparatus 300.

The input/output device 265 may receive data required for operations of the data generation apparatus 200 and may output generated results. The data bus 270 may connect the processor 250, the memory 255, the transceiver 260, the input/output device 265, and the storage 275, and may serve as a transfer path for delivering data among the respective components.

The storage 275 may store application programming interfaces (APIs), library files, and resource files required for execution of the software 280a implementing a method according to the present disclosure. The storage 275 may also store software 280b implementing a method according to the present disclosure. In addition, the storage 275 may store information required for performing a calibration method and a map generation method. In particular, the storage 275 may include a database 285 that stores programs for performing the calibration method and the map generation method.

According to an embodiment of the present disclosure, the software 280a, 280b resident in the memory 255 or stored in the storage 275 may be a computer program recorded on a recording medium for causing the processor 250 to execute a step of extracting a calibration board from each of an image captured by a camera and point cloud data acquired by a LiDAR sensor, a step of identifying feature points of the calibration board included in the image and the point cloud data, and a step of causing calibration of the camera and the LiDAR sensor based on the identified feature points.

According to another embodiment of the present disclosure, software 280a, 280b resident in the memory 255 or stored in the storage 275 may be a computer program recorded on a recording medium for causing the processor 250 to execute a step of placing point cloud data acquired from a LiDAR sensor mounted on a vehicle onto a predefined world coordinate system, a step of extracting a region to be used for calibration from the placed point cloud data, a step of identifying at least one object included in the extracted region, and a step of causing calibration of the point cloud data by fitting point clouds included in the identified at least one object to a pre-stored model.

According to another embodiment of the present disclosure, software 280a, 280b resident in the memory 255 or stored in the storage 275 may be a computer program recorded on a recording medium for causing the processor 250 to execute a step of obtaining first point cloud data acquired from a first LiDAR, a plurality of second point cloud data acquired from a plurality of second LiDAR sensors mounted on a vehicle traveling along a path on a reference map, and specification values of the first LiDAR sensor and the plurality of second LiDAR sensors, a step of causing preprocessing of the first point cloud data and the plurality of second point cloud data, and a step of causing calibration of the preprocessed first point cloud data and the plurality of second point cloud data.

According to still another embodiment of the present disclosure, software 280a, 280b resident in the memory 255 or stored in the storage 275 may be a computer program recorded on a recording medium for causing the processor 250 to execute a step of causing generation of a first feature map based on point cloud data acquired from a LiDAR sensor and images captured by a camera, and a step of causing generation of a third feature map by mapping the first feature map to a second feature map generated from pre-stored point cloud data.

More specifically, the processor 250 may include an Application-Specific Integrated Circuit (ASIC), another chipset, logic circuits, and/or data processing devices. The memory 255 may include a Read-Only Memory (ROM), a Random Access Memory (RAM), a flash memory, a memory card, a storage medium, and/or another storage device. The transceiver 260 may include a baseband circuit for processing wired and wireless signals. The input/output device 265 may include input devices such as a keyboard, a mouse, and/or a joystick; image output devices such as a Liquid Crystal Display (LCD), an Organic Light Emitting Diode (OLED), and/or an Active Matrix OLED (AMOLED); and printing devices such as a printer and a plotter.

When embodiments included in the present specification are implemented as software, the methods described above may be implemented as modules (processes, functions, and so on) that perform the functions described above. The modules may be resident in the memory 255 and may be executed by the processor 250. The memory 255 may be located inside or outside the processor 250, and may be connected to the processor 250 by various well-known means.

Each component illustrated in FIG. 3 may be implemented by various means, for example, by hardware, firmware, software, or a combination thereof. In the case of implementation by hardware, an embodiment of the present disclosure may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In the case of implementation by firmware or software, an embodiment of the present disclosure may be implemented in the form of modules, procedures, or functions that perform the functions or operations described above, and may be recorded on a computer-readable recording medium through various computer means. The recording medium may include program commands, data files, and data structures, either alone or in combination. Program commands recorded on the recording medium may be specially designed and configured for the present disclosure, or may be program commands available to those skilled in the art of computer software. Examples of recording media include magnetic media such as hard disks, floppy disks, and magnetic tapes; optical media such as Compact Disk Read Only Memory (CD-ROM) and Digital Video Disk (DVD); magneto-optical media such as floptical disks; and hardware devices specially configured to store and execute program commands, such as Read-Only Memory (ROM), Random Access Memory (RAM), and flash memory.

Examples of program commands include not only machine language code generated by a compiler, but also high-level language code executable by a computer using an interpreter and the like. Such hardware devices may be configured to operate as one or more software modules to perform operations of the present disclosure, and vice versa.

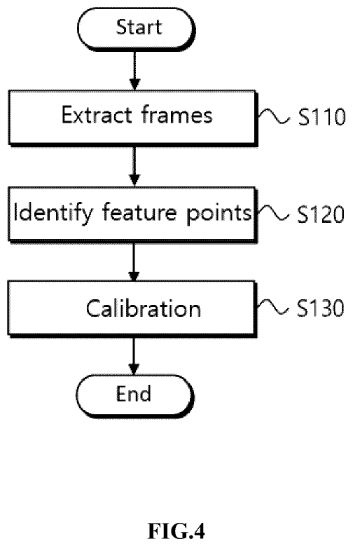

FIG. 4 illustrates a flowchart for explaining a calibration method of a camera and a LiDAR according to an embodiment of the present disclosure. Referring to FIG. 4, in step S110, the data generation apparatus 200 may extract one frame of an image captured by the camera and one frame of point cloud data acquired by the LiDAR. The extracted frame of the image and the extracted frame of the LiDAR may include a calibration board.

In step S120, the data generation apparatus 200 may identify feature points of the calibration board included in each of the extracted frame of the image and the extracted frame of the LiDAR sensor. The calibration board may be a rectangular checker board including a boundary identification region formed of a material having an intensity higher than a preset value, and a top point identification region formed of a material having an intensity lower than a preset value and located at an upper end of the boundary identification region.

Specifically, the data generation apparatus 200 may identify corners of the calibration board in the image based on a size and a number of the calibration boards. At this time, the data generation apparatus 200 may identify points corresponding to the corners based on a preset pattern with reference to a feature point located at an uppermost portion or a lowermost portion of the calibration board, and may assign indices to the identified points.

The data generation apparatus 200 may detect the calibration board in the point cloud data based on the boundary identification region having relatively high intensity, and may identify feature points within the detected calibration board. Specifically, the data generation apparatus 200 may generate a virtual plane based on point clouds included in the boundary identification region, may generate a plurality of straight lines by connecting points located at outermost positions in each channel of the generated virtual plane, may detect vertices of the calibration board based on intersections of the plurality of generated straight lines, and may identify feature points of the calibration board based on the detected vertices.

That is, the data generation apparatus 200 may identify four vertices included in the calibration board, and may identify feature points of the calibration board based on a pre-stored size and a number of the calibration board. The feature points of the calibration board identified from the point cloud data may correspond to the feature points identified from the image. The data generation apparatus 200 may match indices of the feature points identified from the image to the feature points identified from the LiDAR sensor, based on the top point identification region of the calibration board.

In step S130, the data generation apparatus 200 may cause calibration of the camera and the LiDAR sensor based on the feature points identified from the image and the point cloud data. Specifically, the data generation apparatus 200 may calculate extrinsic parameters including a rotation value and a translation value based on the feature points of the calibration board included in the image and the point cloud data, and may cause calibration based on the calculated extrinsic parameters. The data generation apparatus 200 may calculate the rotation value and the translation value separately. Preferably, the data generation apparatus 200 may calculate the rotation value first, and then may calculate the translation value.

First, when the rotation value is defined as a rotation value from a first viewpoint to a second viewpoint, the rotation value may be calculated by Equation 1 below.

$$\vert ( {f}_{1}^{*} {Rf}_{1}^{′} ) ( {f}_{2}^{*} {Rf}^{′} 2 ) ( {f}_{3}^{*} {Rf}_{3}^{′} ) \vert = 0 \qquad [ Equation 1 ]$$

Here, R denotes the rotation value, and f and f′ denote rays from the first viewpoint and the second viewpoint, respectively, to feature points of the calibration board included in the point cloud data. The translation value may be calculated through a loss function based on Re-Projection Error (RPE). The RPE may indicate a degree of distortion of a point projected onto an image relative to an observed point in the image.

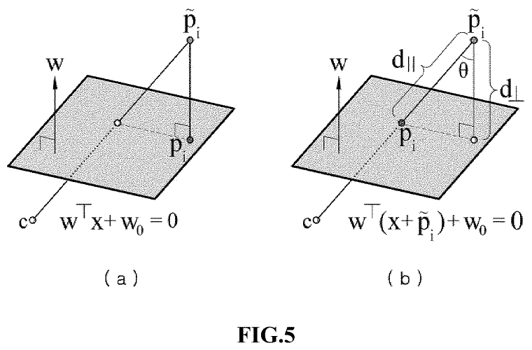

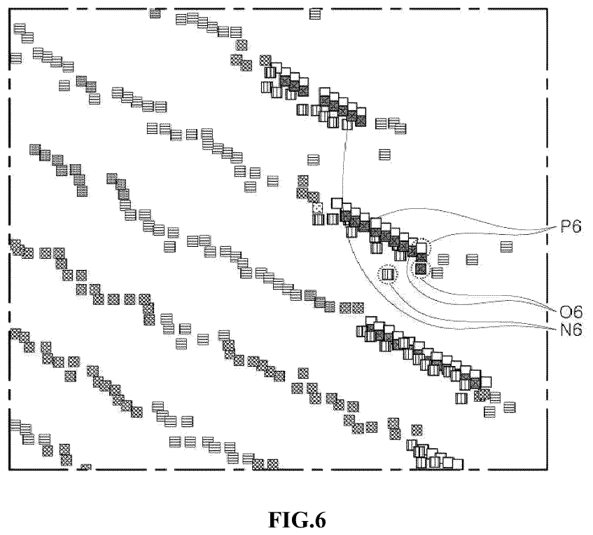

FIGS. 5(a) and 5(b) are diagrams for explaining perspective projection according to an embodiment of the present disclosure, and FIG. 6 is a diagram for comparing effects of perspective projection and orthogonal projection according to an embodiment of the present disclosure.

Accurate calibration of parameters of the LiDAR sensor and the camera is very important in order to cause fusion of data from the two sensors. Many conventional calibration methods have used an orthogonal projection method when projecting LiDAR points onto a target plane. However, the orthogonal projection method may fail to reflect inherent characteristics of LiDAR data, and may cause degradation of calibration accuracy.

In the present disclosure, calibration accuracy has been improved by using a perspective projection method that reflects characteristics of LiDAR data. The perspective projection method may more accurately model a ray casting process in which laser pulses emitted from the LiDAR sensor are reflected by an object and return, and therefore may better reflect characteristics of LiDAR data compared to the orthogonal projection method.

The orthogonal projection method projects LiDAR points onto a target plane in a direction perpendicular to the plane, while ignoring distance and angle information between the position of the LiDAR sensor and the measured LiDAR points.

When noise exists in the LiDAR data, the orthogonal projection method may cause inaccurate calculation of positions of the projected LiDAR points. Errors of the orthogonal projection method may further increase as the target plane becomes closer to the LiDAR sensor or is not perpendicular to a central axis of the LiDAR sensor.

A core of the present disclosure is to use a perspective projection method that considers characteristics of LiDAR data when projecting LiDAR points onto a target plane. Equation 2 below represents a distance ratio between orthogonal projection and perspective projection.

$$\frac{{d}_{⊥}}{{d}_{‖}} = \frac{\vert {w}^{⊤} ( {\tilde{p}}_{i} - c ) \vert}{‖ w ‖ ‖ {\tilde{p}}_{i} - c ‖} = cos θ \qquad [ Equation 2 ]$$

Referring to FIGS. 5(a), 5(b), and Equation 2, d⊥ denotes an orthogonal distance from a LiDAR point to a target plane, d∥ denotes a perspective distance, and θ denotes an angle between a normal vector w of the plane and a ray direction (pi−c), where 0≤θ<π.

In Equation 2, when θ=0, that is, when the ray direction is parallel to the normal vector of the plane, the orthogonal projection and the perspective projection are identical (d⊥=d∥). However, as θ increases, as the ray direction becomes further from the normal vector of the plane, a difference between the orthogonal projection and the perspective projection becomes larger. Accordingly, when the target plane is not perpendicular to a central axis of the LiDAR sensor or is closer to the LiDAR sensor, the perspective projection provides more accurate results.

Since the LiDAR sensor measures distance by using rays, Time of Flight measurement noise occurs along the ray direction. Therefore, the perspective projection may better reflect characteristics of LiDAR data than the orthogonal projection, and may provide more accurate information about the target plane.

In the present disclosure, when an angle formed between the ray direction of the LiDAR sensor and the normal vector of the target plane exceeds a predetermined angle, the point cloud is projected onto the target plane by using perspective projection.

The perspective projection method used in the present disclosure projects a LiDAR point by calculating an intersection of a ray connecting a center of the LiDAR sensor and a measured LiDAR point with the target plane. Because the perspective projection method accurately reflects a ray casting process of LiDAR data, the perspective projection method has the following advantages compared to the orthogonal projection method.

The perspective projection method considers directions of laser pulses emitted from the LiDAR sensor, and therefore is less affected by noise compared to the orthogonal projection method. Even when noise exists in the measured LiDAR points, the processor may project the points to more accurate positions by using perspective projection.

While results of the orthogonal projection method may vary depending on an angle of the target plane, the perspective projection method provides consistent results regardless of the angle of the target plane. The processor may accurately project LiDAR points by using perspective projection, regardless of changes in an angle of the target plane.

Experimental results have also verified superiority of the perspective projection method. The perspective projection method may provide more accurate and consistent results when LiDAR sensor noise is high or when an angle of the target plane becomes further from a central axis of the LiDAR sensor.

FIG. 6 is a diagram illustrating a comparison between projection results of a perspective projection method according to the present disclosure and projection results of a conventional orthogonal projection method. Referring to FIG. 6, LiDAR points of a calibration board are color-coded according to intensity. LiDAR points measured on reflective tape attached to the calibration board include noise N6. The noisy points N6 were projected onto a target plane by using two projection methods, namely, the perspective projection method according to the present disclosure and the conventional orthogonal projection method.

In FIG. 6, points projected by the perspective projection method are indicated as P6, and points projected by the orthogonal projection method are indicated as O6.

As confirmed in FIG. 6, the points P6 are distributed evenly, whereas the points O6 are scattered. This observation indicates that the perspective projection method causes reduced sensitivity to noise present in LiDAR data.

In particular, in a region indicated by a circle in FIG. 6 where noise is large, points projected by using the perspective projection method are distributed on the target plane more evenly and more accurately than points projected by using the orthogonal projection method.

Hereinafter, an operation of the perspective projection according to the present disclosure is described in detail.

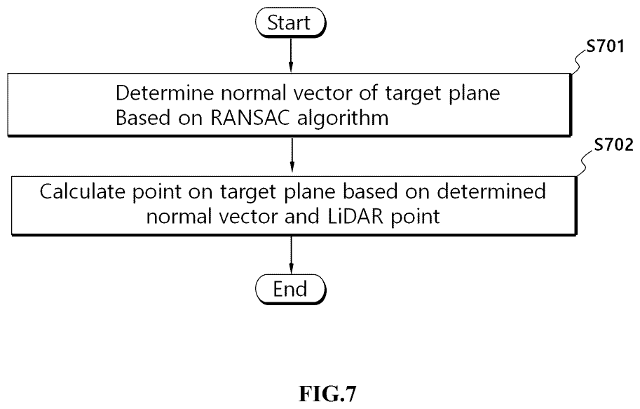

FIG. 7 is a diagram for explaining an operation of determining a target plane according to an embodiment of the present disclosure. Referring to FIGS. 5 and 7 together, the processor may first acquire a three-dimensional point cloud of a surrounding environment by using a LiDAR sensor. The processor may then detect a target region in which a target object used for calibration is located from the three-dimensional point cloud. For example, the target region may be automatically detected by attaching reflective tape around the target object.

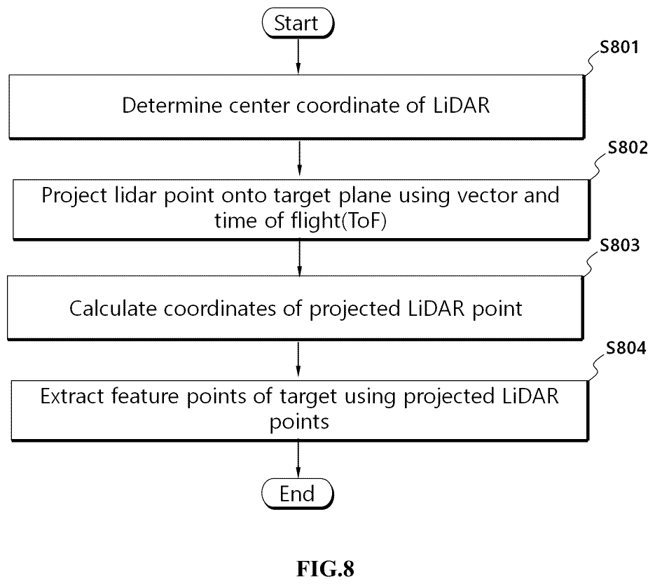

Referring to FIG. 8, an operation of determining intersections between LiDAR sensor rays and a target plane is described. At step S701, the processor estimates a normal vector w of the target plane and a constant value w0 based on a RANSAC algorithm by using LiDAR points belonging to the target region. At step S702, the processor calculates a point on the target plane by using the estimated normal vector w, the constant value w0, and a measured LiDAR point pi.

$${w}^{⊤} ( x + {\tilde{p}}_{i} ) + {w}_{0} = 0. \qquad [ Equation 3 ]$$

Referring to Equation 3, since a process of translating a center of the LiDAR sensor to an origin is performed, the equation is expressed in a form including a pi term. Feature points of a target may be extracted by using points on the target plane calculated as described above. The processor may acquire an image by using a camera, and may extract feature points of the target from the acquired image. Finally, the processor may calculate parameters of the LiDAR sensor and the camera by using correspondence between the feature points of the target extracted from the LiDAR sensor and the feature points of the target extracted from the camera.

A calibration method of the present disclosure particularly uses a perspective projection method to project LiDAR points onto the target plane. That is, as a method of projecting three-dimensional points in space onto the target plane, the perspective projection method defines a ray between each point and a projection center, and calculates an intersection of the ray with a two-dimensional plane. The perspective projection method causes improvement of calibration accuracy by considering inherent characteristics of LiDAR data.

FIG. 8 is a diagram for explaining an operation of determining intersections between LiDAR sensor rays and a target plane according to an embodiment of the present disclosure. Referring to FIGS. 5 and 8 together, a calibration process includes a perspective projection process of finding points on the target plane by using LiDAR data. The processor may first detect a target region from a three-dimensional point cloud acquired from the LiDAR sensor, and may estimate the target plane by using LiDAR points belonging to the target region.

Referring to FIG. 8, an operation of determining intersections between LiDAR sensor rays and a target plane is described. At step S801, for each LiDAR point on the target plane, the processor determines a center coordinate c of the LiDAR sensor. At step S802, the processor projects the LiDAR point onto the target plane by using a vector connecting the center coordinate c of the LiDAR sensor and the LiDAR point, and a Time of Flight ti. At step S803, the processor calculates coordinates pi of the projected LiDAR point. At step S804, the processor extracts feature points of the target by using the calculated LiDAR points.

The LiDAR sensor emits laser rays to measure distances to objects, and generates a three-dimensional point cloud by using the measured distance information. The Time of Flight (ToF) denotes a time taken for a laser pulse to travel from the LiDAR sensor to the measured LiDAR point.

The processor may calculate three-dimensional coordinates pi of the projected LiDAR point by using Equation 5.

$${p}_{i} = - ( {\tilde{p}}_{i} - c ) {t}_{i} \qquad [ Equation 4 ]$$

Equation 4 represents a method of calculating three-dimensional coordinates of an intersection point when a LiDAR point is projected onto a target plane along a ray passing through a center of the LiDAR sensor. Specifically, a distance vector traveled by a laser pulse is calculated by multiplying a vector pi-c connecting a LiDAR sensor center c and a measured LiDAR point pi by a Time of Flight ti. To calculate coordinates when the center of the LiDAR sensor is translated to an origin, a negative sign is applied to the vector (pi−c) ti.

This perspective projection method accurately reflects characteristics of LiDAR data and allows acquisition of accurate information about the target plane. Feature points of the target may be extracted by using the calculated LiDAR points (S804). The processor may extract feature points of the target from an image acquired by the camera. Finally, the processor may calculate parameters of the LiDAR sensor and the camera by using correspondence between the feature points extracted from the LiDAR sensor and the feature points extracted from the camera.

Since data acquired from the LiDAR sensor is based on distance information measured by using laser pulses, a relationship between the LiDAR sensor and each measured point must be considered between a position of the sensor and a measured point. This relationship is expressed as a ray, and the perspective projection method projects three-dimensional points onto a two-dimensional plane by using the ray.

The processor may calculate a Time of Flight (ToF) based on Equation 5.

$${t}_{i} = \frac{{w}^{⊤} {\tilde{p}}_{i} + {w}_{0}}{{w}^{⊤} ( {\tilde{p}}_{i} - c )} \qquad [ Equation 5 ]$$

Equation 5 represents a method of projecting noisy LiDAR points onto a target plane by calculating an intersection between a laser emitted from the LiDAR sensor and the target plane. Specifically, a line connecting a sensor center c and a measured LiDAR point pi is defined, and an intersection of the line with the target plane is calculated.

In Equation 5, ti denotes a time taken for a laser pulse to be emitted from the LiDAR sensor, reflected by an object, and returned; wT denotes a normal vector w of the target plane; pi denotes the measured LiDAR point; w0 denotes a constant term of a target plane equation; and c denotes coordinates of the LiDAR sensor center.

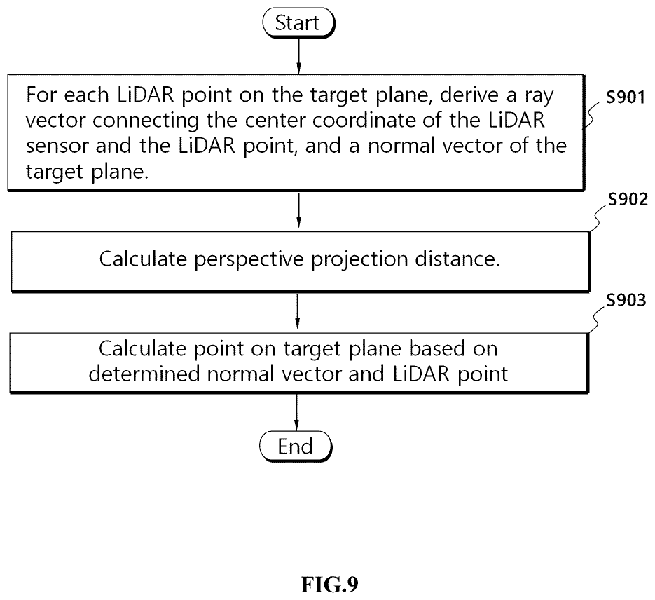

FIG. 9 is a diagram for explaining an operation of projecting LiDAR points onto a target plane by using a perspective projection distance according to an embodiment of the present disclosure. Referring to FIGS. 5 and 9 together, the processor may detect a target region from a three-dimensional point cloud acquired from the LiDAR sensor, and may estimate the target plane by using LiDAR points belonging to the target region.

Referring to FIG. 9, an operation of projecting LiDAR points onto a target plane by using a perspective projection distance is described. At step S901, for each LiDAR point pi on the target plane, the processor derives a ray vector connecting a center coordinate c of the LiDAR sensor and the LiDAR point, and a normal vector w of the target plane. At step S902, the processor calculates a perspective projection distance d∥. At step S903, the processor projects the LiDAR point onto the target plane by using the calculated perspective projection distance d∥. The perspective projection distance d∥ denotes a distance from the sensor center to an intersection point when a point in three-dimensional space is projected onto the target plane along a ray passing through the LiDAR sensor center.

The processor may calculate the perspective projection distance by using the following equation.

$${d}_{‖} = \vert \frac{{w}^{⊤} {\tilde{p}}_{i} + {w}_{0}}{{w}^{⊤} ( {\tilde{p}}_{i} - c )} \vert ‖ {\tilde{p}}_{i} - c ‖ \qquad [ Equation 6 ]$$

Equation 6 presents a method of accurately calculating a perspective projection distance by considering characteristics of LiDAR data. A conventional orthogonal projection method may cause inaccurate results when noise exists in measured LiDAR points, because the conventional orthogonal projection method does not consider directions of laser pulses emitted from the LiDAR sensor. Referring to Equation 6, d∥ denotes the perspective projection distance, w denotes a normal vector w of the target plane, pi denotes a measured LiDAR point, w0 denotes a constant term of the target plane equation, and C denotes a center of the LiDAR sensor. At step S903, the processor may project LiDAR points onto the target plane by using the calculated perspective projection distance d∥.

Hereinafter, an operation for augmented points according to another embodiment of the present disclosure is described. In the present disclosure, the term “point” denotes information constituting point cloud data acquired by a LiDAR sensor. A “feature point” denotes a point constituting a calibration board derived from points, and is used as a reference point required for calibration.

The present disclosure relates to a method for more accurately performing calibration between a LiDAR sensor sensor and a camera sensor. Particularly, augmented points may be generated by using edge points of a calibration target, and feature points may be re-determined by using the augmented points, thereby effectively compensating quantization errors of the LiDAR sensor.

The processor may first capture a calibration target by using a camera sensor, and may acquire point cloud data of the calibration target by using a LiDAR sensor sensor. The calibration target may be a planar object having a known pattern, such as a checkerboard. The acquired point cloud data may be projected onto a plane of the calibration target and may be transformed into a two-dimensional coordinate system. This may be performed by estimating a plane equation of the calibration target and projecting each point cloud onto the plane.

The processor may extract edge points of the calibration target by using the point cloud data transformed into the two-dimensional coordinate system. The edge points may be detected by using density variations of the point cloud data and distance discontinuities. For example, when a distance variation between adjacent points in each scan line exceeds a predetermined threshold, the point may be determined as an edge point.

For each extracted edge point, the processor may generate an augmented point by using a previous edge point on the same scan line. The augmented point may be generated at a position extended beyond a boundary of the calibration target. That is, the augmented point is a virtual point generated by extending a straight line connecting a current edge point and a previous edge point outside a boundary of the calibration target. The augmented point serves to compensate for positional errors of edge points caused by quantization errors of the LiDAR sensor.

The processor may correct feature points of the calibration target by using the edge points and the augmented points. The feature points correspond to corners of the calibration target, and are used as reference points required for calibration. By correcting positions of the edge points by using the augmented points, positions of the feature points may be estimated more accurately. For example, the processor may approximate the edge points to straight lines by using a RANSAC algorithm, and may calculate intersections of the straight lines to correct the feature points.

The processor may calculate parameters between the LiDAR sensor and the camera sensors by using the re-determined feature points. The parameters represent relative positional and directional relationships between the two sensors, and may include a rotation matrix and a translation vector. Since the corrected feature points may also be detected in the camera image, the processor may calculate the parameters by using coordinates of the feature points detected in both sensors. For this calculation, computer vision techniques such as a Perspective-n-Point (PnP) algorithm may be used.

The processor may project the LiDAR point cloud data onto the camera image by using the calculated parameters, and may verify calibration results by evaluating a degree of alignment between the projected point cloud data and the camera image. When the degree of alignment is low, the processor may improve calibration results by repeating the calibration process or by adjusting the parameters.

A calibration method between a LiDAR sensor sensor and a camera sensor according to the present disclosure may be utilized in various fields such as autonomous driving, robotics, and three-dimensional map generation.

The processor may extract edge points of a calibration target by using point cloud data transformed into a two-dimensional coordinate system. The edge points may be detected by using density variations of the point cloud data and distance discontinuities. For example, when a distance variation between adjacent points in each scan line exceeds a predetermined threshold, the processor may determine the point as an edge point.

For each extracted edge point pl_i, pr_i, the processor may determine an augmented point based on Equation 7 below.

$${q}_{i}^{l} = {p}_{i}^{l} + ( {p}_{i}^{l} - {p}_{i}^{l - 1} ) , {q}_{i}^{r} = {p}_{i}^{r} + ( {p}_{i}^{r} - {p}_{i}^{r - 1} ) \qquad [ Equation 7 ]$$

Referring to Equation 7, ql_i may denote a left augmented point of a scan line, qr_i may denote a right augmented point of the scan line, pl_i may denote a left feature point of the scan line, pr_i may denote a right feature point of the scan line, pl−1_i may denote a left edge point of an l−1th scan line, and pr−1_i may denote a right edge point of an r−1th scan line. Equation 7 provides a method for calculating augmented points to solve such a problem. The processor may generate a point closer to an actual boundary line by extrapolating an edge point in a measured direction by using the augmented point.

The processor may calculate the augmented points in order to more accurately estimate a boundary of a calibration target by using LiDAR data. The LiDAR data consists of distance information measured by angles of respective channels and has a discrete data form rather than continuous data. Accordingly, edge points extracted based on distance discontinuities in each channel are not located on the actual boundary line but are located inside the actual boundary line.

The processor may generate a point closer to the actual boundary line by extrapolating the edge point in a measured direction by using the augmented point. The processor may generate the augmented point by calculating a vector between an edge point of a current scan line and an edge point of a previous scan line by using Equation 7, and by extrapolating by an amount corresponding to the vector between the edge points of the scan lines. That is, the processor may generate the augmented point at an extrapolated position corresponding to the vector between the edge points of the scan lines.

The processor may enable more accurate boundary estimation by constraining a boundary of the calibration target to pass between the augmented point generated as described above and the edge point, by using the augmented point together with the edge point.

A boundary estimation method using augmented points may be more effective as the calibration target becomes more distant from the LiDAR sensor. As the target becomes farther from the sensor, a distance between the edge points and the augmented points increases, thereby enabling more accurate constraint of the boundary line.

The processor may first detect edge points of the calibration target by using LiDAR data, and may estimate initial feature points of the calibration target by using the detected edge points. However, due to characteristics of LiDAR data, the edge points are located inside the actual boundary line of the calibration target, and therefore the initial feature points may include positional errors relative to the actual position.

To reduce the errors, the processor may generate augmented points for each edge point by using Equation 7 described above. The augmented points are located on straight lines extending from the edge points in a direction of the boundary line of the calibration target, and are located closer to the actual boundary line than the edge points.

Meanwhile, Equation 8 defines an edge-based cost function Eedge used to accurately find a plane boundary line.

$${E}_{edge} = {\sum }_{i = 1}^{c} d ( {1}^{l} , {p}_{i}^{l} ) + d ( {1}^{l} , {q}_{i}^{l} ) + d ( {1}^{r} , {p}_{i}^{r} ) + d ( {1}^{r} , {q}_{i}^{r} ) \qquad [ Equation 8 ]$$

Equation 8 may be used to set a constraint such that a boundary line passes between an edge point and an augmented point. In Equation 8, c denotes a number of LiDAR sensor channels scanning a target plane, l and r denote left and right boundary lines defined as corner points, and d(l, p) denotes a distance between a line l and a point p along a scan line. When the boundary line is located between the edge point and the augmented point, the cost function has a minimum value, and when the boundary line deviates from this range, the cost function value increases. Accordingly, the processor may define the boundary line of the target to be located between the edge point and the augmented point.

Referring to Equation 8, a value of dout+din in a case of ci becomes smaller than a value of dout+din in a case of ci+1. The ci case satisfies the constraint of Equation 8, but the ci+1 case does not satisfy the constraint of Equation 8, and therefore the points and the augmented points need to be re-determined. Meanwhile, a location-based loss function may be defined as follows.

$${E}_{position} = {\sum }_{i = 1}^{4} ‖ {c}_{i} - {\overline{c}}_{i} ‖ \qquad [ Equation 9 ]$$

Equation 9 may represent Eposition as a sum of a distance between a feature point and a nearest edge point, and a distance between the feature point and an augmented point. The processor may re-determine the feature points by minimizing Eedge by using the generated augmented points and the edge points.

Eedge is defined as a sum of distances from each edge point and each augmented point to left and right feature points, and by minimizing Eedge, the feature points may be adjusted closer to an actual boundary line. In addition, the processor may re-determine the feature points by using the following equation.

$$E = {E}_{edge} + λ {E}_{position} \qquad [ Equation 10 ]$$

Referring to Equation 10, Eposition represents a sum of a distance between a feature point and a nearest point, and a distance between the feature point and an augmented point. λ denotes a parameter that adjusts weights of two cost functions. That is, the processor may determine the feature points based on a distance Eedge between a boundary line of a target and edge points and augmented points, and on a distance Eposition between the feature points and the edge points and augmented points.

The processor may perform calibration between a LiDAR sensor and a camera sensor by using size information of a calibration board. The processor may first acquire size information of the calibration board. The size information may be provided by a manufacturer of the calibration board or may be directly measured and input by a user.

The processor may calculate parameters between the LiDAR sensor and the camera sensors and may perform calibration by using the acquired size information of the calibration board. A parameter calculation method using the calibration board is as follows. The processor may simultaneously acquire LiDAR data and camera image data. The processor may extract feature points of the calibration board from the acquired data. The processor may calculate a transformation relationship between the LiDAR sensor and the camera sensors by using three-dimensional position information of the extracted feature points and two-dimensional image coordinate information.

The size information of the calibration board may be used to accurately calculate three-dimensional position information of the feature points of the calibration board. As a result, the processor may accurately calculate parameters between the LiDAR sensor and the camera sensors by using the size information of the calibration board, and may improve performance of a sensor fusion system.

The processor may improve accuracy by sequentially performing rotation calibration and translation calibration between a LiDAR sensor and a camera sensor. The processor may first extract feature points from image data and point cloud data. Thereafter, the processor may calculate a rotational transformation relationship between the LiDAR sensor and the camera sensor by performing rotation calibration based on the extracted feature points. After the rotation calibration is completed, the processor may calculate a translational transformation relationship between the LiDAR sensor and the camera sensor by performing translation calibration.

Particularly, when the LiDAR sensor and the camera sensor are arranged in parallel, a translation offset is very small, and an essential matrix may be difficult to calculate. In this case, the processor may secure robustness of calibration by first estimating a relative transformation by using a rotational constraint.

Meanwhile, conventional calibration methods were sensitive to initial guesses and had disadvantages of being trapped in local minima. The present disclosure solves such problems by using a Particle Swarm Optimization (PSO) algorithm. The PSO algorithm may perform optimization stably and efficiently without initial guesses, and may be less sensitive to local minima problems.

A calibration method of the present disclosure includes the following steps. First, a target plane is located at an origin of a LiDAR sensor coordinate system. Thereafter, the processor may optimize rotational and translational transformations of the LiDAR sensor sensor by using the PSO algorithm. The PSO algorithm efficiently searches a search space by using a plurality of particles, and each particle represents candidate values of rotational and translational transformation parameters. The particles move in a direction that minimizes a cost function, and the PSO algorithm finds optimal rotational and translational transformation parameters that minimize a total cost function E.

As described above, a total cost function is composed of a sum of a base cost function Eedge and a location-based cost function Eposition, and is defined as E=Eedge+ë Eposition. The edge-based cost function is calculated by using edge points and augmented points, and the location-based cost function constrains estimated corner points to be close to initial guesses. Finally, calibration between the LiDAR sensor sensor and a target plane is completed by using optimized rotational and translational transformation parameters.

According to the present disclosure, calibration between a LiDAR sensor sensor and a target plane may be performed stably and efficiently without initial guesses. In addition, the calibration method may be less sensitive to local minima problems, thereby enabling acquisition of more accurate calibration results.

As a result, the processor may accurately perform calibration between the LiDAR sensor and the camera sensor by sequentially performing rotation calibration and translation calibration. The processor may first estimate a rotational transformation relationship between the LiDAR sensor and the camera sensor by using a Translation Independent Rotation Constraint technique. This technique is a method for solving a problem in which calculation of an essential matrix becomes difficult when the LiDAR sensor and the camera sensor are arranged in parallel and a translation offset is very small.

The processor may construct epipolar planes by using 3D-2D correspondences, and may calculate normal vectors of the respective epipolar planes. Since the normal vectors are all perpendicular to a translation vector, an eigenvector corresponding to a minimum eigenvalue of a covariance matrix of the normal vectors represents a direction of the translation vector. The processor may perform translation calibration between the LiDAR sensor and the camera sensor by using the eigenvector corresponding to the minimum eigenvalue of the covariance matrix of the normal vectors of the epipolar planes.

The processor may calculate a magnitude of the translation vector by using the estimated translation vector direction and the 3D-2D correspondences, and may finally estimate both the rotational transformation relationship and the translational transformation relationship between the LiDAR sensor and the camera sensor. That is, the processor may sequentially perform the rotation calibration and the translation calibration by the above-described method.

Equation 11 illustrates a process of finely adjusting the estimated parameters by using a Perspective-n-Point (PnP) algorithm.

$$min {\sum }_{i = 1}^{m} {‖ {}^{C} {f}_{i} - π ( {R}_{L}^{C L} {f}_{i} + {}^{C} {t}_{CL} ) ‖}^{2} \qquad [ Equation 11 ]$$

Referring to Equation 11, Cfi denotes normalized coordinates of an i-th camera image feature point, Lfi denotes three-dimensional coordinates of an i-th LiDAR point cloud feature point, R\hat{ }CL denotes a rotational transformation matrix from a LiDAR sensor coordinate system to a camera sensor coordinate system, t\hat{ }CL denotes a translational transformation vector from the LiDAR sensor coordinate system to the camera sensor coordinate system, and π denotes a projection function onto a camera image plane. The processor may finely adjust the parameters by minimizing a reprojection error of Equation 11 through a nonlinear optimization technique such as a Levenberg-Marquardt algorithm.

As a result, the processor may more accurately perform calibration between the LiDAR sensor and the camera sensor through a coarse-to-fine parameter optimization process.

As described above, preferred embodiments of the present disclosure have been disclosed in the present specification and the drawings. However, in addition to the disclosed embodiments, other modifications based on the technical spirit of the present disclosure may be implemented, which will be apparent to those skilled in the art. Specific terms used in the present specification and the drawings

What is claimed is:

1. A calibration method comprising:
extracting, by a data generation apparatus, one frame of an image captured by a camera and one frame of point cloud data acquired by a LiDAR sensor, wherein the point cloud data comprises a plurality of LiDAR points;
identifying, by the data generation apparatus, feature points of a calibration board included in each of the extracted image and the extracted one frame of the LiDAR sensor; and
performing, by the data generation apparatus, calibration of the camera and the LiDAR sensor based on the identified feature points,
wherein performing the calibration comprises:
generating, by the data generation apparatus, a target plane by applying a RANSAC algorithm based on the feature points of the calibration board; and
projecting, by the data generation apparatus, the point cloud data onto the target plane by performing a perspective projection.

2. The method of claim 1, wherein projecting the point cloud data onto the target plane comprises:
determining a normal vector and a constant value of the target plane by applying the RANSAC algorithm to the LiDAR points belonging to the target plane; and
calculating an equation of the target plane based on the normal vector, the constant value, and the measured LiDAR points.

3. The method of claim 2, wherein identifying the feature points comprises:
projecting each of the plurality of LiDAR points onto the target plane by using a vector connecting a center coordinate of the LiDAR sensor and the LiDAR point, and a Time of Flight (ToF); and
extracting the feature points by using coordinates of the projected LiDAR points.

4. The method of claim 3, wherein the Time of Flight (ToF) of the LiDAR sensor is determined based on the equation of the target plane and the center coordinate of the LiDAR sensor.

5. The method of claim 1, wherein performing the perspective projection comprises:
calculating a perspective projection distance for each LiDAR point coordinate on the target plane based on a ray vector connecting a center coordinate of the LiDAR sensor and the LiDAR point coordinate, and a normal vector of the target plane; and
projecting the LiDAR point coordinate onto the target plane by using the calculated perspective projection distance.

6. The method of claim 1, wherein performing the calibration comprises:
calculating extrinsic parameters including a rotation value and a translation value based on the feature points included in each of the image and the point cloud data; and
performing the calibration based on the calculated extrinsic parameters.

7. The method of claim 6, wherein performing the calibration comprises calculating the rotation value and the translation value separately.

8. A data generation apparatus for performing calibration of a camera and a LiDAR sensor by using a perspective projection method, the data generation apparatus comprising:
a memory; and
at least one processor communicatively coupled to the memory,
wherein the at least one processor is configured to:
extract one frame of an image captured by a camera and one frame of point cloud data acquired by a LiDAR sensor, wherein the point cloud data comprises a plurality of LiDAR points;
identify feature points of a calibration board included in each of the extracted image and the extracted one frame of the LiDAR sensor;
perform calibration of the camera and the LiDAR sensor based on the identified feature points;
generate a target plane by applying a RANSAC algorithm based on the feature points of the calibration board; and
project the point cloud data onto the target plane by performing a perspective projection.

9. The apparatus of claim 8, wherein the at least one processor is configured to:
determine a normal vector and a constant value of the target plane by applying the RANSAC algorithm to the LiDAR points belonging to the target plane; and
calculate an equation of the target plane based on the normal vector, the constant value, and the measured LiDAR points.

10. The apparatus of claim 9, wherein the at least one processor is configured to:
project each of the plurality of LiDAR points onto the target plane by using a vector connecting a center coordinate of the LiDAR sensor and the LiDAR point, and a Time of Flight (ToF); and
extract the feature points by using coordinates of the projected LiDAR points.
